(19) United States
(12) Patent Application Publication
(10) Pub. No.: US 2022/0297504 A1
(43) Pub. Date: Sep. 22, 2022

(54) REFRIGERATION SYSTEM WITH A HEAT PUMPING AND REHEATING FUNCTION

(71) Applicant: AUDI AG, Ingolstadt (DE)

(72) Inventors: Dirk SCHROEDER, Manching (DE); Christian REBINGER, München (DE); Helmut ROTTENKOLBER, Mindelstetten (DE)

(73) Assignee: AUDI AG, Ingolstadt (DE)

(21) Appl. No.: 17/638,419

(22) PCT Filed: Sep. 22, 2020
(86) PCT No.: PCT/EP2020/076387

§ 371 Date: Feb. 25, 2022

(30) Foreign Application Priority Data
Oct. 7, 2019 (DE) 10 2019 126 850.8

(51) Int. Cl. B60H 1/00; B60H 1/32

(52) U.S. Cl. CPC B60H 1/00921; B60H 1/00542; B60H 1/32281; B60H 2001/00928; B60H 2001/00949; B60H 2001/00957; B60H 2001/3285

(57) ABSTRACT

A modular cooling system for a vehicle including a base module having a refrigerant compressor, a high-pressure section having a direct or indirect condenser or gas cooler, and a low-pressure section having an evaporator and a chiller having chiller expansion elements connected upstream. The low-pressure section is connected via a heat pump expansion element to the high-pressure section. A first supplementary module has a heating branch having a heat pump heat exchanger, which is connectable via a first reheating branch having a valve element to the direct or indirect condenser or gas cooler, and a heat pump recirculation branch having a blockable valve element for connecting the direct or indirect condenser or gas cooler to the low-pressure section.

### FIELD

The invention relates to a modular cooling system for a vehicle.

### BACKGROUND

Vehicle climate control systems can have different functionalities, so that in addition to the basic functions, such as heating, cooling, and dehumidifying the supply air supplied into the vehicle interior, heat pump functionalities and reheating functions are also implementable.

A combined cooling system having heat pump function is known from DE 10 2011 118 162 A1, in which a heat register is used in a first operating mode to heat a vehicle interior, wherein the heat register is assisted in a further mode by an evaporator. A heat exchanger which can have bidirectional flow through is operated as a condenser in the cooling system operation and absorbs heat from the surroundings in heat pump operation as the heat pump evaporator.

A vehicle climate control system having heat pump function is distinguished according to DE 10 2015 121 185 A1 in that the refrigerant circuit has an evaporator which can have bidirectional flow through it to assist the heating of the supply air supplied into a vehicle interior by means of a heat register. Refrigerant permanently flows through the heat register, wherein in a cooling system operation, an ambient heat exchanger is connected downstream of the heat register, and in a heat pump operation, an auxiliary heat exchanger or the ambient heat exchanger has flow through it as a heat source.

Finally, DE 10 2017 208 228 A1 also describes a vehicle climate control system having multiple bidirectional heat exchangers, the operating modes of which are switched over by a reversal of a flow direction of a fluid within the heat exchanger.

Different functionalities can be implemented using the known vehicle climate control systems wherein different interconnections are used for this purpose. To be able to meet specific customer wishes, in general the refrigerant circuits have to be adapted accordingly, due to which the expenditure for development and production of specific refrigerant circuits increases and thus also the costs rise.

### SUMMARY

It is therefore the object of the invention to provide a modular cooling system for a vehicle, with which a high level of flexibility is implementable with respect to the implementation of systems having different functionalities.

Such a modular cooling system for a vehicle comprises the following components:

a) a base module, having

a1) a refrigerant compressor,

a2) a high-pressure section, which is connectable to the high-pressure outlet of the refrigerant compressor by means of a blocking element, having a direct or indirect condenser or gas cooler, wherein the direct or indirect condenser or gas cooler is operable in a cooling system operation and in a heat pump operation, and

a3) a low-pressure section, which is connected to the low pressure inlet of the refrigerant compressor, having at least one evaporator and a chiller having chiller expansion elements connected upstream, wherein the low-pressure section is connected upstream via a heat pump expansion element to the high-pressure section, which is used in the cooling system operation as an evaporator expansion element of the evaporator,

b) a first supplementary module, having

b1) a heating branch, connectable to the high-pressure outlet of the refrigerant compressor by means of a blocking element, having a heat pump heat exchanger, which is connectable via a first reheating branch having a blockable valve element to the direct or indirect condenser or gas cooler, and

b2) a heat pump recirculation branch having a blockable valve element for connecting the direct or indirect condenser or gas cooler to the low-pressure section, and

c) a second supplementary module, having

c1) a preheating branch having a preheating expansion element, wherein the preheating branch connects the heat pump exchanger on the outlet side to the evaporator on the inlet side, and

c2) a blockable valve element, which is connected to the outlet of the evaporator.

According to the invention, the cooling system for a vehicle is constructed from multiple modules, namely a base module for implementing the basic function “cooling” and at least two supplementary modules, wherein the first supplementary module assumes the functions of heating by means of a heat pump function and reheating functions for dehumidifying the supply air supplied to the vehicle interior. Using the second supplementary module, it is possible to use the evaporator as an air preheater for heating in addition to the heat pump heat exchanger.

A large number of circuit variants can be implemented using this modular cooling system according to the invention, so that for each operating point or operating situation of the cooling system, a maximum selection and maximum options exist for ideal interconnection and selection of active components.

A further advantage of this modular cooling system is that the number of functions is reduced by dispensing with the second supplementary module and/or the first supplementary module and thus also components until finally only a basic cooling system is available using the base module.

A modular cooling system is now available with this invention, with which individual cooling systems can be constructed and different functionalities can be represented in a flexible manner.

One advantageous refinement is provided in that the blockable valve element of the second supplementary module is replaced by an expansion element. The evaporator can thus be operated at an intermediate pressure which enables dehumidifying operation at ambient temperatures below 0° C.

One preferred refinement of the invention provides a third supplementary module, which has a second reheating branch having a blockable valve element, wherein the second reheating branch connects the heat pump heat exchanger on the outlet side to the heat pump expansion element. A direct connection to the condenser or gas cooler, to the chiller, and in particular to the evaporator is thus enabled via the heat pump heat exchanger to carry out a reheating operation.

Furthermore, according to the refinement, a fourth supplementary module is provided in which the evaporator is connected on the inlet side to an evaporator expansion element. A flexible refrigerant distribution is thus possible via the evaporator and the chiller in cooling operation.

Finally, according to a last preferred embodiment of the invention, a fifth supplementary module is provided, in which the blockable valve element of the first reheating branch is designed as a reheating expansion element. In a reheating operation, a third pressure level can thus be implemented in addition to the low-pressure and high-pressure levels.

Further advantages, features, and details of the invention result from the following description of preferred embodiments and on the basis of the drawings. In the figures:

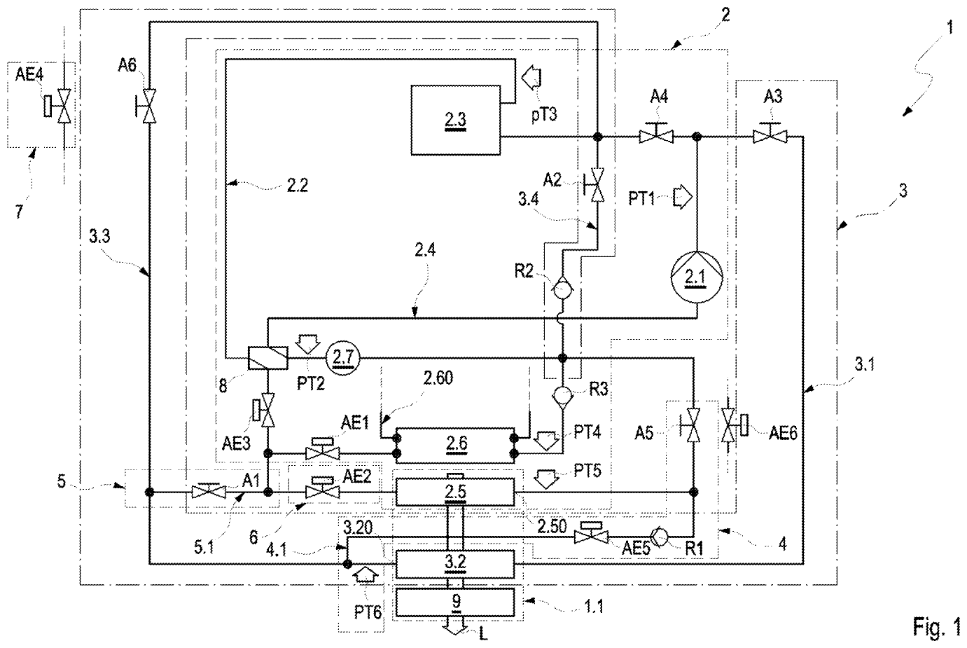

FIG. 1 shows a modular cooling system according to the invention having a base module and a first, second, third, fourth, and fifth supplementary module,

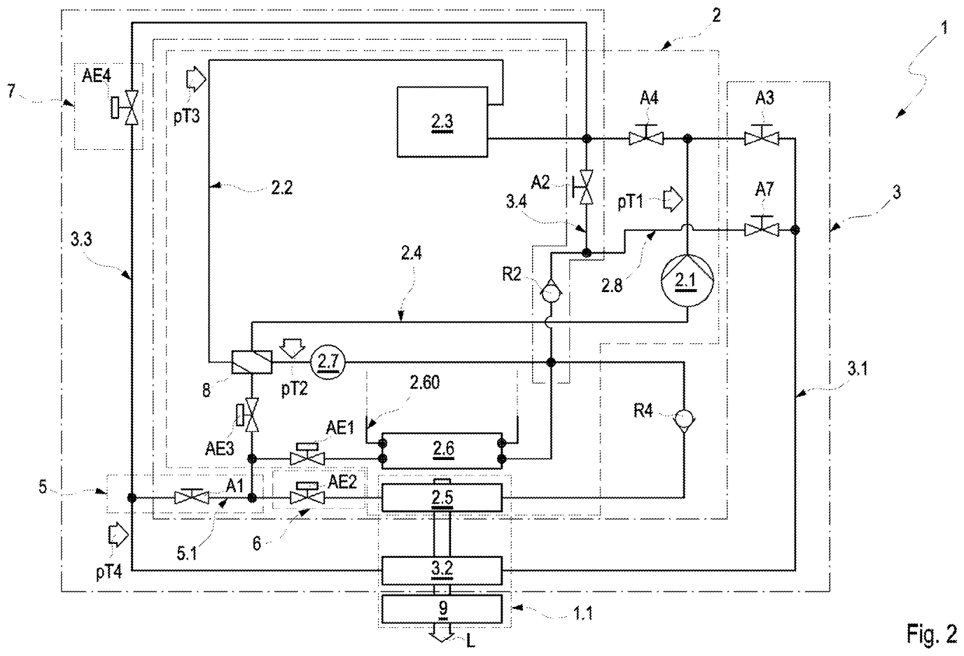

FIG. 2 shows a modular cooling system according to the invention having a base module and a first, third, fourth, and a fifth supplementary module, but without a second supplementary module, and

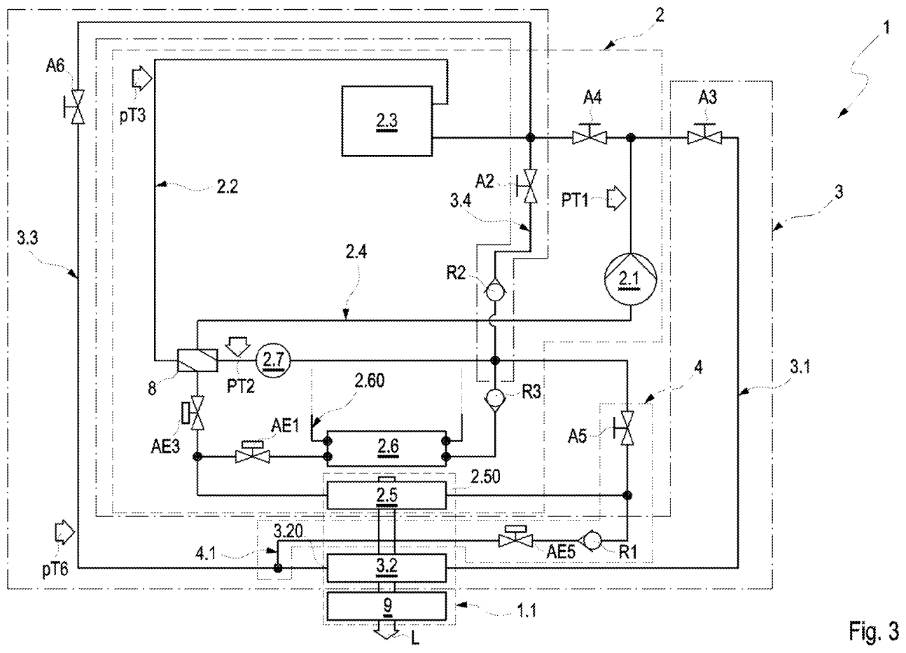

FIG. 3 shows a modular cooling system according to the invention having a base module and a first and second supplementary module.

The modular cooling system 1 according to FIG. 1 consists of a base module 2 and multiple supplementary modules, namely a first supplementary module 3, a second supplementary module 4, a third supplementary module 5, a fourth supplementary module 6, and a fifth supplementary module 7, which are shown by the numbers 3, 4, 5, 6, and 7 and can be operated both in a cooling system operation (referred to in short as AC operation) and also in a heat pump operation (referred to in short as WP operation), wherein the heating operation is carried out by means of a heat pump function.

The base module 2 comprises a refrigerant circuit having the following components and line sections:
a refrigerant compressor 2.1
a high-pressure section 2.2, which is connectable to the high-pressure outlet of the refrigerant compressor 2.1 by means of a blocking element A4, having a direct or indirect condenser or gas cooler 2.3, wherein the direct or indirect condenser or gas cooler 2.3 is operable in a cooling system operation and in a heat pump operation, and
a low-pressure section 2.4, which is connected to the low-pressure inlet of the refrigerant compressor 2.1, having an evaporator 2.5 and a chiller 2.6 having chiller expansion elements AE1 connected upstream, wherein the low-pressure section 2.4 is connected upstream via a heat pump expansion element AE3 to the high-pressure section 2.2.

The direct or indirect condenser or gas cooler 2.3 is used for the heat exchange with the surroundings of the vehicle.

The chiller 2.6, which is thermally connected to a refrigerant circuit 2.60, is used for cooling an electrical component of the vehicle, for example a high-voltage battery.

A cooling function, thus an AC operation, can be carried out using this base module 2. In this case, the blockable valve element A4 can be omitted and is replaced by a line section connecting the high-pressure outlet of the refrigerant compressor 2.1 to the direct or indirect condenser or gas cooler 2.3. The heat pump expansion element AE3 is connected directly upstream of the evaporator 2.5 as the evaporator expansion element, so that the chiller branch from the chiller 2.6 and the chiller expansion element AE1 assigned thereto are connected in parallel to the evaporator branch from evaporator 2.5 and the evaporator expansion element assigned thereto.

According to FIG. 1, the base module 2 also has a low-pressure accumulator 2.7 arranged in the low-pressure section 2.4 and an internal heat exchanger 9 having a high-pressure section and the low-pressure section.

The first supplementary module 3 comprises the following components and line sections:
a heating branch 3.1, which is connectable to the high-pressure outlet of the refrigerant compressor 2.1 by means of a blocking element A3, having a direct or indirect heat pump heat exchanger 3.2 (also called heat register), which is connectable via a first reheating branch 3.3 having a blockable valve element A6 to the direct or indirect condenser or gas cooler 2.3, and
a heat pump recirculation branch 3.4 having a blockable valve element A2 for connecting the direct or indirect condenser or gas cooler 2.3 to the low-pressure section 2.4.

The heat pump recirculation branch 3.4 also comprises a check valve R2, using which a return flow of refrigerant from the chiller 2.6 and/or the evaporator 2.5 into the heat pump recirculation branch 3.4 is prevented.

Using this first supplementary module 3, both a heating function by means of an air and/or water heat pump function and also various reheating functions may be carried out.

The direct heat pump heat exchanger 3.2 shown here is installed together with the evaporator 2.5 in an air conditioner 1.1, wherein to condition a supply airflow L guided into a vehicle interior, this flow is first guided via the evaporator 2.5 and subsequently via the heat pump heat exchanger 3.2 and possibly via an electrical heating element 9. This heating element 9 is embodied, for example, as a high-voltage PTC heating element.

The second supplementary module 4 comprises the following components and line sections:
a preheating branch 4.1 having a preheating expansion element AE5, wherein the preheating branch 4.1 connects the heat pump heat exchanger 3.2 on the outlet side to the evaporator 2.5 on the inlet side, and
a blockable valve element A5, which is connected to the outlet of the evaporator 2.5.

Using this second supplementary module 4, the evaporator 2.5 may be used as a pre-heater, wherein in this case the refrigerant flows through the evaporator 2.5 in the opposite direction in comparison to the AC operation.

The third supplementary module 5 comprises a second reheating branch 5.1 having a blockable valve element A1, wherein the second heating branch 5.1 connects the heat pump heat exchanger 3.2 on the outlet side to the heat pump expansion element AE3. Therefore, via the heat pump heat exchanger 3.2, a direct connection to the direct or indirect condenser or gas cooler 2.3 via the heat pump expansion element AE3, to the chiller 2.6, and to the evaporator 2.5 to carry out a reheating operation is enabled.

Using the fourth supplementary module 6, an evaporator expansion element AE2 is connected upstream from the evaporator 2.5 on the inlet side. A flexible refrigerant distribution via the evaporator 2.5 and the chiller 2.6 is thus possible in cooling operation of the cooling system 1.

Using the fifth supplementary module 7, the blockable valve element A6 of the first reheating branch 3.3 is replaced by a reheating expansion element AE4. In a reheating operation, in addition to the low-pressure and high-pressure levels, a third pressure level can thus be implemented, the so-called intermediate-pressure level.

The cooling system 1 has multiple pressure-temperature sensors as sensors for controlling and regulating the system.

A first pressure-temperature sensor pT1 is thus preferably assigned to the refrigerant compressor 5 at the high-pressure outlet, furthermore a second pressure-temperature sensor pT2 at the outlet of the low-pressure accumulator 2.7, a third pressure-temperature sensor pT3 at the outlet of the direct or indirect condenser or gas cooler 2.3, a fourth pressure-temperature sensor pT4 at the outlet of the chiller 2.6, a fifth pressure-temperature sensor pT5 at the outlet of the evaporator 2.5, and a sixth pressure-temperature sensor pT6 at the outlet of the heat pump heat exchanger 3.2.

The AC operation and the heating operation of the cooling system 1 are explained hereinafter.

Using the blocking elements A3 and A4 arranged at the high-pressure outlet of the refrigerant compressor 2.1, the refrigerant flow is conducted starting from the high-pressure side of the refrigerant compressor 2.1 in dependence on the status of these two blocking elements A3 and A4 either, with open blocking element A4 and blocked blocking element A3, into the high-pressure section 2.2 to carry out an AC operation or flows, with open blocking element A3 and closed blocking element A4, to carry out a heating operation or reheating operation by means of a heat pump function in the heating branch 3.1.

In AC operation of the cooling system 1, the refrigerant compressed to high pressure flows starting from the refrigerant compressor 2.1 with open blocking element A4 into the direct or indirect condenser or gas cooler 2.3, the high-pressure section of the internal heat exchanger 8, via the completely open heat pump expansion element AE3 by means of the evaporator expansion element AE2 into the evaporator 2.5, and/or by means of the chiller expansion element AE1 into the chiller 2.6. From the chiller 2.6, the refrigerant flows via a check valve R3, the low-pressure accumulator 2.7, and the low-pressure section of the internal heat exchanger 8 back to the refrigerant compressor 2.1, while the refrigerant flows from the evaporator 2.5 via the blocking element A5 of the second supplementary module 4 and can also subsequently flow via the low-pressure accumulator 2.7 and the low-pressure section of the internal heat exchanger 8 back to the refrigerant compressor 2.1.

The heating operation of the cooling system 1 is to be described hereinafter. For this purpose, a heat pump operation is carried out by means of at least one heat source. In heat pump operation, the cabin supply airflow L supplied to the vehicle interior is heated by means of the heat pump heat exchanger 3.2 of the first supplementary module 3 and possibly guided via a heating element 9, before the supply airflow L can flow into the vehicle interior.

In heating operation of the cooling system 1 using the chiller 2.6 to implement a water heat pump or using the direct or indirect condenser or gas cooler 2.3 as a heat pump evaporator for implementing an air heat pump, the blocking element A4 is closed and the blocking element A3 is opened, so that hot refrigerant can flow into the heating branch 3.1.

To carry out the water heat pump operation by means of the chiller 2.6, the refrigerant compressed by means of the refrigerant compressor 2.1 flows via the heating branch 3.1 into the heat pump heat exchanger 3.2 to emit heat to the supply airflow L and is subsequently expanded via the open blocking element A1 by means of the chiller expansion element AE1 in the chiller 2.6 to absorb waste heat of the electrical and/or electronic components arranged in the refrigerant circuit 2.60. In this heating function, the heat pump expansion element AE3 and the reheating expansion element AE4 are closed. Refrigerant evacuated in water heat pump operation is suctioned out of the high-pressure section 2.2 via the open blocking element A2 of the heat pump recirculation branch 3.4 and supplied via the check valve R2 to the refrigerant compressor 2.1.

The heat pump heat exchanger 3.2 can be designed, in addition to direct condensation or gas cooling, also as a refrigerant-heatsink fluid heat exchanger indirectly heating the airflow, wherein the heatsink fluid is, for example, a water-glycol mixture.

To carry out the air heat pump operation by means of the direct or indirect condenser or gas cooler 2.3 as the heat pump evaporator, the refrigerant flows out of the heat pump heat exchanger 3.2 via the open blocking element A1 into the high-pressure section 2.2 and is expanded by means of the heat pump expansion element AE3 in the direct or indirect condenser or gas cooler 2.3 to absorb heat from the ambient air and subsequently flows via the heat pump recirculation branch 3.4 back to the refrigerant compressor 2.1. The expansion elements AE1, AE2, and AE4 remain closed here.

If a combination operation of water heat pump and air heat pump is implemented, in addition to the chiller expansion element AE1, the heat pump expansion element AE3 is thus also actively incorporated via a control unit and both are activated accordingly to set and achieve the target variables.

In a reheating operation, the supply airflow L supplied into the vehicle interior is first cooled by means of the evaporator 2.5 and thus dehumidified to subsequently at least partially heat the supply airflow L again using the heat withdrawn from the supply airflow L and the heat supplied to the refrigerant via the refrigerant compressor 2.1 by means of the heat pump heat exchanger 3.2.

A reheating operation of the cooling system 1 is carried out in dependence on the heat balance in different ways.

In the event of a heat excess in reheating operation, in addition to the heat emission to the supply airflow L of the vehicle interior via the heat pump heat exchanger 3.2, heat is additionally emitted to the surroundings of the vehicle via the direct or indirect condenser or gas cooler 2.3, before the refrigerant flows via the evaporator 2.5 back to the refrigerant compressor 2.1 again. For this purpose, the refrigerant flows out of the heat pump heat exchanger 3.2 with closed blocking element A1 of the second reheating branch 5.1 into the first reheating branch 3.3. The refrigerant is depressurized to a moderate pressure in the direct or indirect condenser or gas cooler 2.3 there by means of the reheating expansion element AE4. Subsequently, the refrigerant flows via the internal heat exchanger 8 into the evaporator 2.5, where it is previously expanded by means of the evaporator expansion element AE2 to low pressure.

Alternatively, in the event of sufficient available heating power at the heat pump heat exchanger 3.2, the reheating expansion element AE4 can be opened enough that ideally the same high-pressure level is applied in the heat pump heat exchanger 3.2 and in the direct or indirect condenser or gas cooler 2.3. If such an intermediate-pressure level is not desired in addition to the low-pressure and high-pressure levels, the reheating expansion elements AE4 can be replaced by the blocking element A6.

In the event of a heat deficiency, i.e., in the event of a heating power deficit at the heat pump heat exchanger 3.2, in addition to the evaporator 2.5, the chiller 2.6 is also used as a source.

In this reheating operation, first with open blocking element A3, refrigerant flows through the heating branch 3.1 and thus also the heat pump heat exchanger 3.2, which refrigerant is subsequently depressurized with open blocking element A1 both in the evaporator 2.5 and in the chiller 2.6 by means of the associated expansion elements AE1 and AE2. The heat pump expansion element AE3 and the reheating expansion element AE4 are closed during this reheating operation.

From the evaporator 2.5, the refrigerant flows via the blocking element A5, the low-pressure accumulator 2.7, and the internal heat exchanger 8 back to the refrigerant compressor 2.1 again. The refrigerant from the chiller 2.6 also flows via the check valve R3, the low-pressure accumulator 2.7, and the internal heat exchanger 8 back to the refrigerant compressor 2.1 again. The heat absorbed in the evaporator 2.5 and in the chiller 2.6 is emitted together with the heat flow introduced via the refrigerant compressor 2.1 via the heat pump heat exchanger 3.2 back to the supply airflow L guided into the vehicle interior.

Alternatively, in the event of a heat deficiency, the direct and indirect condenser or gas cooler 2.3 can be used either instead of the chiller 2.6 as a heat source or can be connected in parallel to the chiller 2.6 as an additional heat source.

In the event of sufficient heating power in the refrigerant circuit 2, the refrigerant only flows through the evaporator 2.5.

Switching over between the above-described operating modes takes place via an activation of the individual blocking elements, which are designed either as blocking valves or as expansion valves.

Using the second supplementary module 4, the evaporator 2.5 may be used in conjunction with the heat pump heat exchanger 3.2 as a preheater in various heat pump interconnections.

For this purpose, the preheating branch 4.1 is provided with the preheating expansion element AE5, which connects the outlet 3.20 of the heat pump heat exchanger 3.2 to the outlet 2.50 of the evaporator 2.5, wherein the outlet 2.50 relates to the AC operation. A check valve R1 is arranged between the preheating expansion element AE5 and the outlet 2.50 of the evaporator 2.5 in the preheating branch 4.1, so that a refrigerant flow from the evaporator 2.5 in AC operation into the preheating branch 4.1 is prevented. Alternatively, the check valve can also be omitted, however, in this case an accurate detection of a pressure level change at the evaporator 2.5 and at the heating register 3.5 has to take place to effectuate opening and closing of the preheating expansion element AE5 correctly for the demand/situation via control unit. The blocking element A5 of the second supplementary module 4 is arranged downstream of the evaporator 2.5 and the preheating branch 4.1, so that refrigerant from the evaporator 2.5 and possibly from the preheating branch 4.1, due to the refrigerant suctioning which has taken place from an inactive system section, is guided first via the blocking element A5 and subsequently via the low-pressure accumulator 2.7 and the low-pressure section of the internal heat exchanger 8 back to the refrigerant compressor 2.1.

The refrigerant compressed to high pressure by the refrigerant compressor 2.1 flows through the heat pump heat exchanger 3.2 embodied as a heat register directly into this preheating branch 4.1 and is moderately expanded by means of the preheating expansion element AE5 in the evaporator 2.5 while emitting heat to the supply airflow L supplied to the vehicle interior, or is conducted unexpanded into the evaporator while maintaining the permissible pressure values. The blocking element A5 also connected to the outlet 2.50 of the evaporator 2.5 is blocked, so that a return flow of the refrigerant directly to the refrigerant compressor 2.1 is prevented. The refrigerant conducted into the evaporator 2.5 subsequently flows via the completely open evaporator expansion element AE2 and is subsequently depressurized via the chiller expansion element AE1 in the chiller 2.6, without a volume flow being generated on the refrigerant side. In this way, an indirect triangular process is implemented as the heat pump process. The refrigerant is subsequently guided via the low-pressure accumulator 2.7 and the internal heat exchanger 8 back to the refrigerant compressor 2.1.

Using this supplementary module 4, further dehumidifying processes can be carried out by means of the evaporator 2.5, in particular if an ambient temperature of less than 0° C. is present to carry out a reheating operation and the ambient air component in the supply airflow L is increased for the vehicle interior and a need for drying could therefore exist.

For a dehumidifying process in the context of a reheating operation, the blocking element A5 is embodied as an expansion element AE6, so that the refrigerant is depressurized via the heat pump heat exchanger 3.2 with open blocking element A1 by means of the evaporator expansion element AE2 to an intermediate pressure level in the evaporator 2.5 at a vaporization temperature of greater than 0° C. Subsequently, the refrigerant is depressurized by means of the blocking element A5 embodied as expansion element AE6 to low pressure level and returned via the low-pressure accumulator 2.7 and the internal heat exchanger 8 to the refrigerant compressor 2.1.

For a further dehumidifying process in the context of a reheating operation, the refrigerant is expanded via the preheating branch 4.1 by means of the preheating expansion element AE5 to intermediate pressure level in the evaporator 2.5 in the reverse direction in comparison to the AC operation, wherein the intermediate pressure level is also set by means of the evaporator expansion element AE2 in addition. The refrigerant subsequently flows with expansion by means of the chiller expansion element AE1 and/or by means of the heat pump expansion element AE3 into the direct or indirect condenser or gas cooler 2.3 to use these components as further heat sources.

In summary, a large number of interconnection variants and thus many options for system operation are provided with respect to this cooling system 1 according to FIG. 1.

Starting from this cooling system 1 according to FIG. 1, the number of the functions can be reduced and thus a simpler and therefore more cost-effective circuit variant can be implemented by reducing the supplementary modules and by a matching exchange of components.

Thus, FIG. 2 shows a cooling system 1 which is constructed without the second supplementary module 4 in comparison to the cooling system 1 according to FIG. 1. In place of the valve element A5 (cf. FIG. 1), a check valve R4 is provided, so that a backflow of refrigerant from the chiller 2.6 into the evaporator 2.5 is prevented. Since now a preheating branch is not provided, flow only takes place unidirectionally through the evaporator 2.5.

The cooling system 1 according to FIG. 2 furthermore has a suction branch 2.8 having a blocking element A7. This suction branch 2.8 connects the heating branch 3.1 between blocking element A3 and the heat pump heat exchanger 3.2 to the blocking element A2 and the check valve R2 of the heat pump recirculation branch 3.4.

The heat pump heat exchanger 3.2 is used to heat the vehicle interior, possibly in conjunction with a high-voltage heater 9.

Using this cooling system 1 according to FIG. 2, the reheating functions described in conjunction with the cooling system 1 according to FIG. 1 can also be implemented.

The cooling system 1 according to FIG. 3 is also conceived starting from the cooling system 1 according to FIG. 1. This cooling system 1 consists of the base module 2 and the first supplementary module 3 and the second supplementary module 4.

In this cooling system 1 according to FIG. 3, the heat pump heat exchanger 3.2 is used as a heater and the evaporator 2.5 as an air preheater, wherein the evaporator 2.5 can have flow through it bidirectionally. A reheating function having heat excess is implementable via the reheating branch 3.3 having the blocking element A6.

### LIST OF REFERENCE SIGNS

1 cooling system
1.1 air conditioner
2 base module
2.1 refrigerant compressor
2.2 high-pressure section
2.3 direct or indirect condenser or gas cooler
2.4 low-pressure section
2.5 evaporator
2.50 outlet of the evaporator 2.5 in AC operation
2.6 chiller
2.7 low-pressure accumulator
2.8 suction branch
3 first supplementary module
3.1 heating branch
3.2 heat pump heat exchanger
3.20 outlet of the heat pump heat exchanger 3.2
3.3 first reheating branch
3.4 heat pump recirculation branch
4 second supplementary module
4.1 preheating branch
5 third supplementary module
5.1 second reheating branch
6 fourth supplementary module
7 fifth supplementary module
8 internal heat exchanger
9 electrical high-voltage heater
A1 blocking element
A2 blocking element
A3 blocking element
A4 blocking element
A5 blocking element
A6 blocking element
A7 blocking element
AE1 chiller expansion element
AE2 evaporator expansion element
AE3 heat pump expansion element
AE4 reheating expansion element
AE5 preheating expansion element
AE6 expansion element
L supply airflow
R1 check valve
R2 check valve
R3 check valve
R4 check valve
pT1 pressure-temperature sensor
pT2 pressure-temperature sensor
pT3 pressure-temperature sensor
pT4 pressure-temperature sensor
pT5 pressure-temperature sensor
pT6 pressure-temperature sensor

1-5. (canceled)

6. A modular cooling system for a vehicle, comprising:
a base module, having a refrigerant compressor, a high-pressure section, which is connectable to the high-pressure outlet of the refrigerant compressor by a blocking element, having a direct or indirect condenser or gas cooler, wherein the direct or indirect condenser or gas cooler is operable in a cooling system operation and in a heat pump operation, and a low-pressure section, which is connected to the low-pressure inlet of the refrigerant compressor, having at least one evaporator and a chiller having chiller expansion elements connected upstream, wherein the low-pressure section is connected upstream via a heat pump expansion element to the high-pressure section, a first supplementary module, having a heating branch, connectable to the high-pressure outlet of the refrigerant compressor by a blocking element, having a heat pump heat exchanger, which is connectable via a first reheating branch having a blockable valve element to the direct or indirect condenser or gas cooler, and a heat pump recirculation branch having a blockable valve element for connecting the direct or indirect condenser or gas cooler to the low-pressure section, and a second supplementary module, having a preheating branch having a preheating expansion element, wherein the preheating branch connects the heat pump exchanger on the outlet side to the evaporator on the inlet side, and a blockable valve element, which is connected to the outlet of the evaporator.

7. The modular cooling system as claimed in claim 6, in which the blockable valve element of the second supplementary module is replaced by an expansion element.

8. The modular cooling system as claimed in claim 6, further comprising a third supplementary module, having a second reheating branch having a blockable valve element, wherein the second reheating branch connects the heat pump heat exchanger on the outlet side to the heat pump expansion element.

9. The modular cooling system as claimed in claim 8, further comprising a fourth supplementary module, in which the evaporator is connected on the inlet side to an evaporator expansion element.

10. The modular cooling system as claimed in claim 9, further comprising a fifth supplementary module, in which the blockable valve element of the first reheating branch is designed as a reheating expansion element.
